(19) United States
(12) Patent Application Publication
(10) Pub. No.: US 2019/0136593 A1
(43) Pub. Date: May 9, 2019

(54) APPLIANCE DOOR HOLDER

(71) Applicant: DPX Distribution, LLC, Centennial, CO (US)

(72) Inventor: Steven C. McCallister, Castle Pines, CO (US)

(21) Appl. No.: 16/183,032

(22) Filed: Nov. 7, 2018

Related U.S. Application Data
(60) Provisional application No. 62/583,772, filed on Nov. 9, 2017.

(51) Int. Cl. E05C 17/04; D06F 39/14; E05C 17/56

(52) U.S. Cl. CPC E05C 17/047; E05C 17/56; D06F 39/14

(57) ABSTRACT

An appliance door holder has an F-shaped body with a spine, a first arm extending from a first end of the spine, a second arm extending from the spine in the same direction as the first arm, and a foot at a second end of the spine. A proximal portion of the spine extends between the first arm and second arm, wherein the first and second arms are sized and spaced to receive a door rim of an appliance. The foot includes at least one magnet for magnetically attaching to a body or an opening sidewall of the appliance.

### INCORPORATION BY REFERENCE STATEMENT

The entirety of U.S. Provisional Application Ser. No. 62/583,772 filed Nov. 9, 2017, is hereby expressly incorporated by reference herein.

### BACKGROUND OF THE INVENTIVE CONCEPTS

### 1. Field of the Inventive Concepts

The inventive concepts disclosed and claimed herein relate generally to appliance doors, and more particularly, but not by way of limitation, to an appliance door holder.

### 2. Brief Description of Related Art

It is often desirable to prop open an appliance door to improve circulation and prevent mold build-up during periods of non-use. For example, refrigerator doors, particularly those on campers and recreational vehicles, have extended periods of non-use when the door should remain open. A number of door props are available; however, the props can often disengage with movement, or allow the door to swing open repeatedly.

Front loaded laundry washing machines can also benefit from a door prop. While front loaded washing machines offer many advantages over standard top loaded machines, including minimal laundry damage, efficiencies in water use, and energy savings, a problem that arises is growth of mold and mildew within the wash chamber and associated surfaces and components due to the repeated exposure to water and other wash liquids. For example, a flexible seal about the washer door prevents water from coming out the door when in use. However, this flexible seal also traps moisture which promotes mold that can then get onto the very clothes the machine was designed to clean. A factor contributing to this problem is the lack of effective air venting within the wash chamber when the washer door is closed. Left unaddressed, this can result in unsanitary conditions and an unpleasant smell. Some front load laundry washing machines are equipped with a door that swings open but has no mechanism for positively maintaining the door in an open position.

Many manufacturers instruct users to keep washing machine doors slightly open between cycles and to prop refrigerator doors open during extended periods of non-use to allow air to circulate. However, since many appliance doors swing about a nominally vertically arranged hinge axis, in the event that the appliance is installed on an uneven surface, the door may tend to swing to a closed position under force of gravity. Even in a level installation, a slight inadvertent inward push on the door may cause it to close. Thus, the access doors of many appliances are not reliably retained in an open position to allow for adequate venting of the inner chamber.

Accordingly, there exists a need for a mechanism suitable for use with an appliance having an access door that will maintain the access door in a slight open position, to thereby provide reliable chamber venting.

### SUMMARY OF THE INVENTIVE CONCEPTS

In one embodiment, an appliance door holder comprises an F-shaped body having a spine, a first arm extending from a first end of the spine, a second arm extending from the spine in the same direction as the first arm, and a foot at a second end of the spine. A proximal portion of the spine extends between the first arm and second arm which are spaced to receive a door rim of an appliance. A distal portion of the spine extends between the second arm and the foot which includes at least one magnet.

In another embodiment, the appliance door holder comprises a generally F-shaped body having a spine, a first arm extending from a first end of the spine, a second arm extending from the spine in the same direction as the first arm, and a foot at a second end of the spine. A proximal portion of the spine extends between the first arm and second arm. The first and second arms are spaced apart to receive a door rim of an appliance. The foot comprises at least one magnet.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a perspective view of an appliance door holder constructed in accordance with the inventive concepts disclosed herein.

FIG. 2 is a top plan view of the appliance door holder of FIG. 1.

FIG. 3 is a left side elevational view of the appliance door holder of FIG. 1.

FIG. 4 is a front elevational view of the appliance door holder of FIG. 1.

FIG. 5 is a right side elevational view of the appliance door holder of FIG. 1.

FIG. 6 is a bottom plan view of the appliance door holder of FIG. 1

FIG. 7 shows an example placement of the appliance door holder in a front-load washing machine.

FIG. 8 is a detailed design for a base of a prototype appliance door holder.

FIG. 9 is a detailed design for a lid of the prototype appliance door holder base shown in FIG. 8.

FIG. 10 is a perspective view of another appliance door holder embodiment constructed in accordance with the inventive concepts disclosed herein.

FIG. 11 is a top plan view of the appliance door holder of FIG. 10.

FIG. 12 is a left side elevational view of the appliance door holder of FIG. 10.

FIG. 13 is a front elevational view of the appliance door holder of FIG. 10.

FIG. 14 is a right side elevational view of the appliance door holder of FIG. 10.

FIG. 15 is a bottom plan view of the appliance door holder of FIG. 10.

FIG. 16 is a digital image of a base and lid of the appliance door holder of FIG. 10.

FIG. 17 is a digital image of the appliance door holder of FIG. 16 partially assembled.

FIG. 18 is a photograph of a prototype appliance door holder.

FIG. 19 is a digital image of a second prototype appliance door holder.

### DETAILED DESCRIPTION OF EXEMPLARY EMBODIMENTS

Before explaining at least one embodiment of the presently disclosed inventive concept(s) in detail, it is to be understood that the presently disclosed inventive concept(s) is not limited in its application to the details of construction and the arrangement of the components or steps or methodologies set forth in the following description or illustrated in the drawings. The presently disclosed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed inventive concept(s) shall have the meanings that are commonly understood by those of ordinary skill in the art. Further, unless otherwise required by context, singular terms shall include pluralities and plural terms shall include the singular.

All of the articles and/or methods disclosed herein can be made and executed without undue experimentation in light of the present disclosure. While the articles and methods of the presently disclosed inventive concept(s) have been described in terms of preferred embodiments, it will be apparent to those of skill in the art that variations may be applied to the articles and/or methods and in the steps or in the sequence of steps of the method described herein without departing from the concept, spirit, and scope of the presently disclosed inventive concept(s). All such similar substitutes and modifications apparent to those skilled in the art are deemed to be within the spirit, scope, and concept of the presently disclosed inventive concept(s).

As utilized in accordance with the present disclosure, the following terms, unless otherwise indicated, shall be understood to have the following meanings:

The use of the word “a” or “an” when used in conjunction with the term “comprising” in the claims and/or the specification may mean “one”, but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

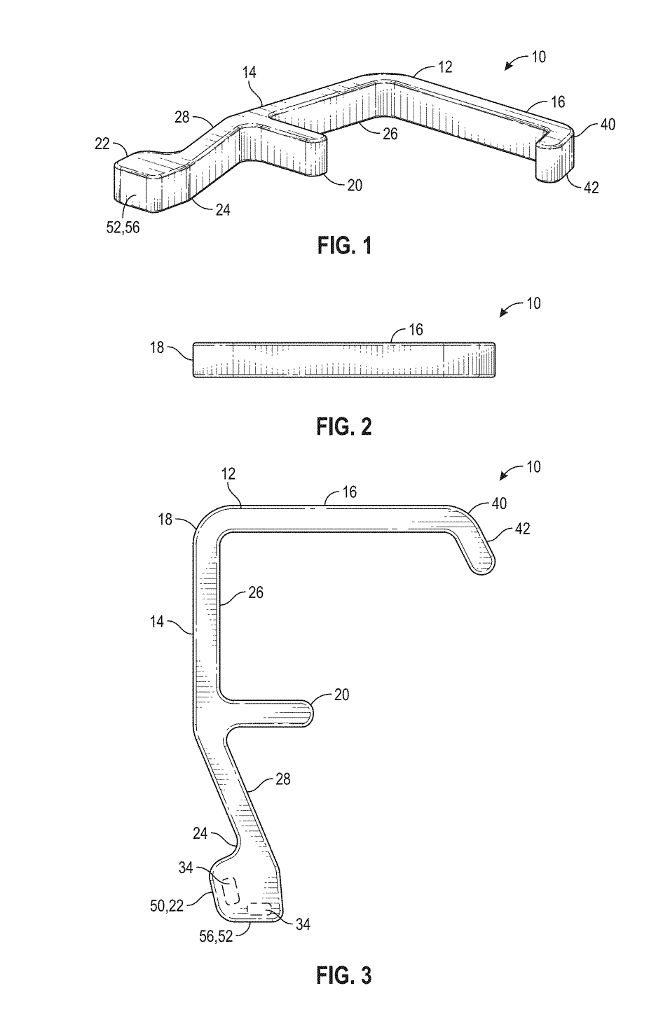

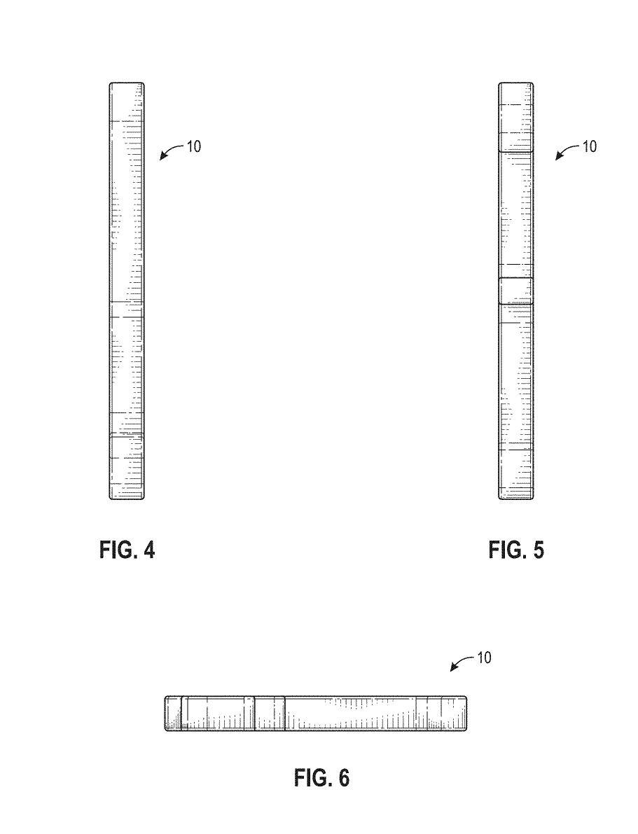

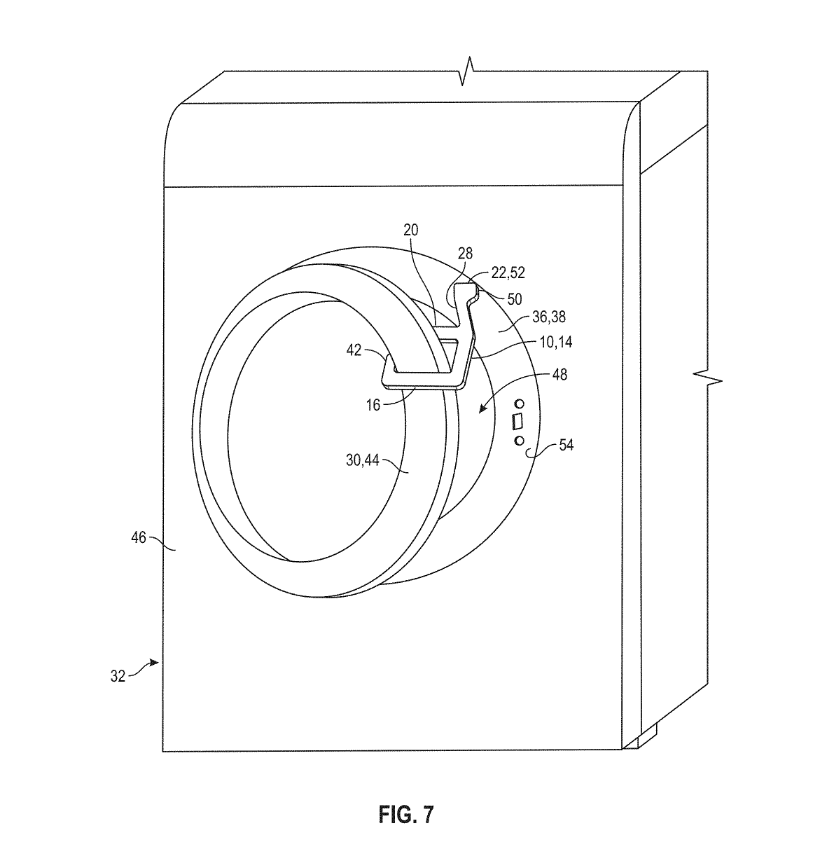

Referring now to the drawings, and more particularly to FIGS. 1-7, shown therein is an exemplary embodiment of an appliance door holder 10 constructed in accordance with the inventive concepts disclosed and claimed herein. The appliance door holder 10 has a generally F-shaped body 12 with a spine 14, a first arm 16 extending from a first end 18 of the spine 14, a second arm 20 extending from the spine 14 in the same direction as the first arm 16, and a foot 22 at a second end 24 of the spine 14. A proximal portion 26 of the spine 14 extends between the first arm 16 and second arm 20, and a distal portion 28 of the spine 14 extends between the second arm 20 and the foot 22. As shown in FIG. 7, the first and second arms 16 and 20, respectively, are spaced to receive a door rim 30 of an appliance 32. The foot 22 includes at least one magnet 34 for magnetically attaching to a body 36 or an opening sidewall 38 of the appliance 32.

In one embodiment, the first arm 16 and the second arm 20 extend in a direction perpendicular to the proximal portion 26 of the spine 14.

In one embodiment, a distal end 40 of the first arm 16 includes a lip 42 extending inwardly. In use, the lip 42 can be placed to wrap about the door rim 30 to better secure the appliance door 44.

In one embodiment, the distal portion 28 of the spine 14 angles inwardly from the proximal portion 26 of the spine 14. Many front loaded washing machines, for example, are designed such that the opening sidewall 38 angles from the front exterior 46 of the appliance 32 toward the inner washing chamber 48. The degree of inward angle of the distal portion 28 can be made to approximate or generally follow the angle of the opening sidewall 38 of the appliance 32. While the angle does not need to match exactly, the presence of an angle assists in placement of the appliance door holder 10 and stability of the door holder 10 once placed on the appliance 32 to hold the appliance door 44 in a slightly open position.

In one embodiment, the at least one magnet 34 is positioned on or near an outer edge 50 of the foot 22. Such placement allows the at least one magnet 34 to magnetically attach to an angled opening sidewall 38.

In one embodiment, the at least one magnet 34 is positioned on a distal end 52 of the foot 22. Such placement allows the at least one magnet 34 to magnetically attach to an opening edge 54 of the appliance 32.

In yet another embodiment, a magnet is present at both positions, i.e., at least one magnet 34 is positioned on or near the outer edge 50 of the foot 22 and at least one magnet 34 is positioned on the distal end 52 of the foot 22.

The at least one magnet 34 can be on an exterior surface 56 of the foot 22, within the foot but partially exposed on the exterior surface 56 of the foot 22, or completely enclosed within the foot 22. Marring or scratching of the appliance surface can be lessened or minimized enclosing the at least one magnet 34 within the foot 22.

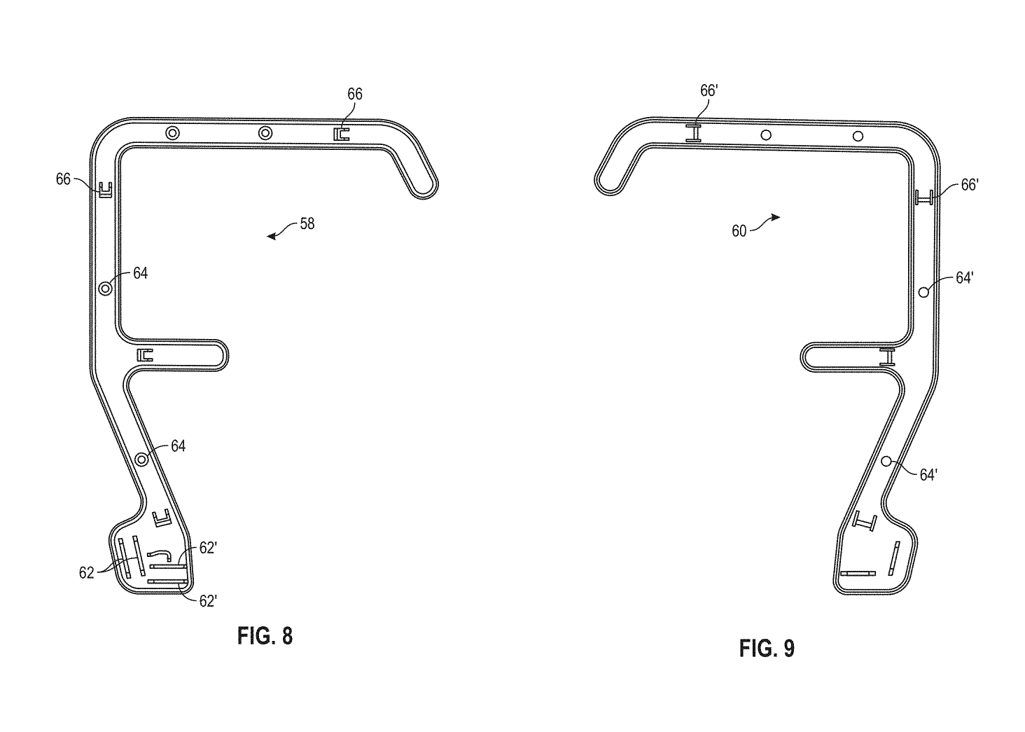

In one exemplary embodiment, the appliance door holder 10 is constructed of two pieces: a base 58 and a lid 60. FIG. 8 and FIG. 9 show multiple views of the base 58 and the lid 60, respectively. A first magnet (not shown) is positioned within containment walls 62 in the base 58. A second magnet is positioned within containment walls 62′ in the base 58. To assist in alignment of the base 58 and lid 60, positioning pins 64 and 64′ are arranged such that positioning pins 64 in the base 58 comprise an orifice for receiving positioning pins 64′ in the lid. The base 58 is attached to the lid 60 using clip components 64 and 64′ to achieve a snap fit.

The one or more magnets 34 can be made of ceramic ferrite, rare earths, and other materials known to those skilled in the art. For example, suitable permanent magnetic materials include strontium ferrite, samarium cobalt, neodymium iron boride, alnico (aluminum, nickel, cobalt). The magnet shape can be a rectangular bar, round bar, disc(s), and the like.

The appliance door holder 10 can be made of plastic, wood, natural and synthetic rubber, composites, combinations thereof, or other material(s) compatible with the appliance 32. In one embodiment, the appliance door holder 10 is formed of a thermoplastic. Nonlimiting examples of suitable thermoplastics include acrylic, polyethylene, polypropylene, polystyrene, and polyvinyl chloride.

In one embodiment, the appliance door holder 10 can be made from a thermosetting polymer. Nonlimiting examples of thermosetting polymers include acrylic resins, epoxy, polyurethane, and the like.

In one embodiment, the appliance door holder 10 is formed of a flexible material. This allows the appliance door holder 10 to deform and recover without breaking when, for example, a person pushes against the appliance door while the appliance door holder 10 is in place. Polymeric materials used for the flexible plastic appliance door holder 10, include but are not limited to, polyolefins, polyesters, polyamides (NYLON™) and poly(tetrafluoroethylene) (TEFLON®).

The appliance door holder 10 can be manufactured using processes such as injection molding, press molding, generative fabrication process, and the like.

In one embodiment, the appliance door holder 10 is manufactured using a generative fabrication process. Examples of suitable generative fabrication processes include, but are not limited to, stereolithography, fused layer modeling, layer laminate manufacturing, 3-D printing, and laser sintering. In one embodiment, the generative fabrication process utilized is 3-D printing.

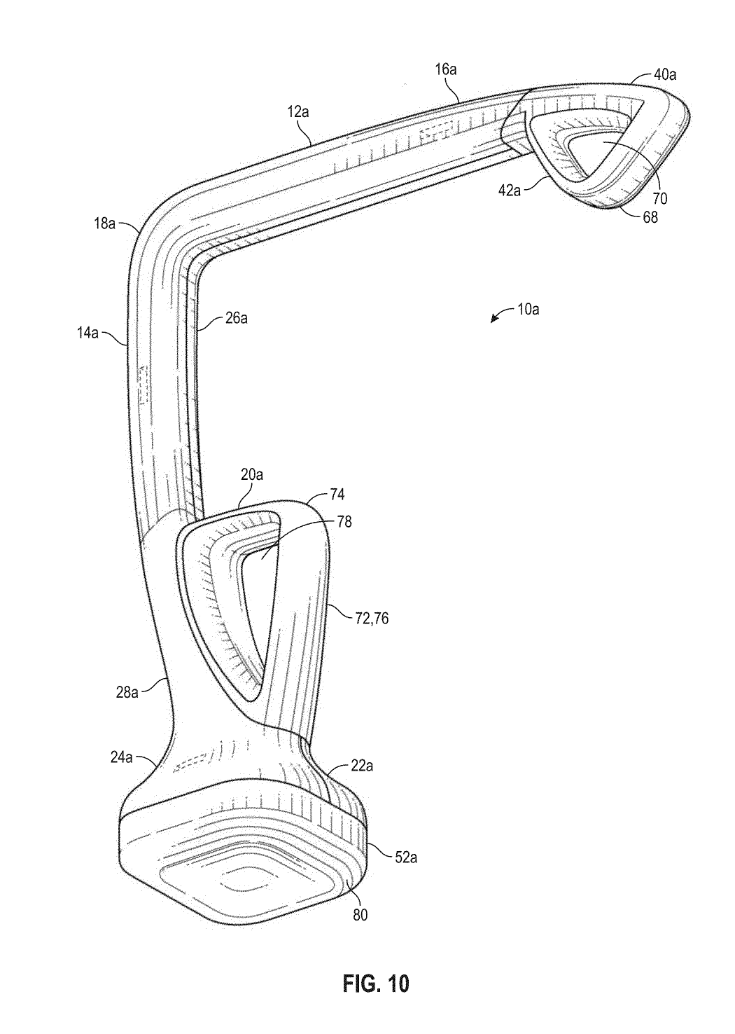

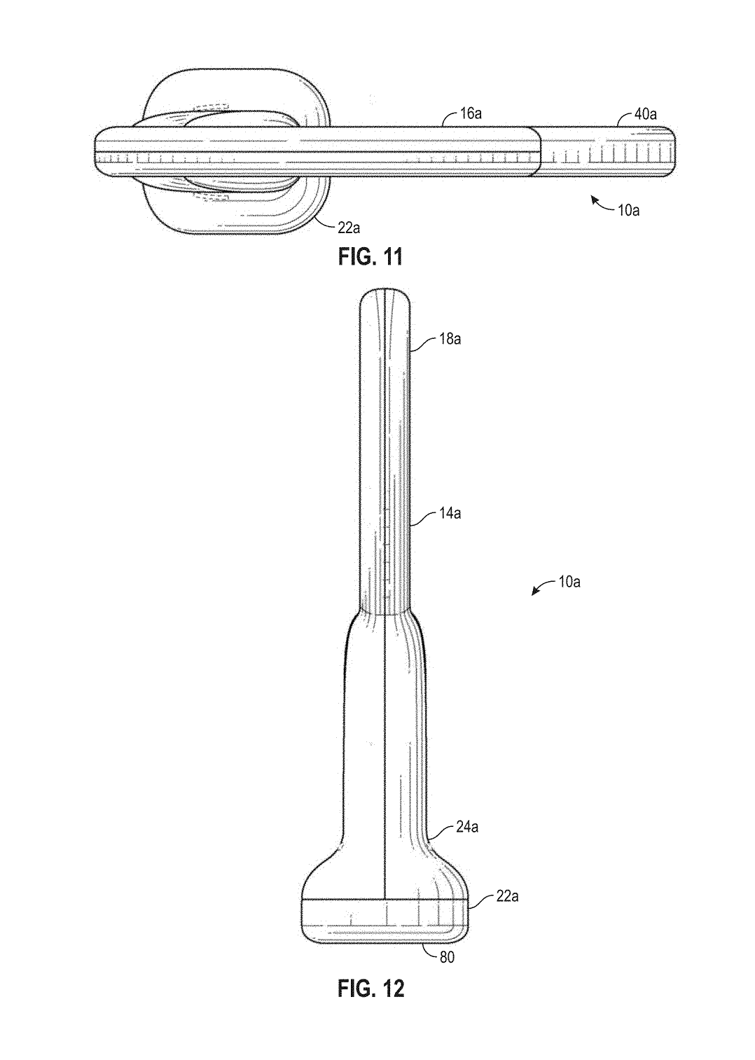

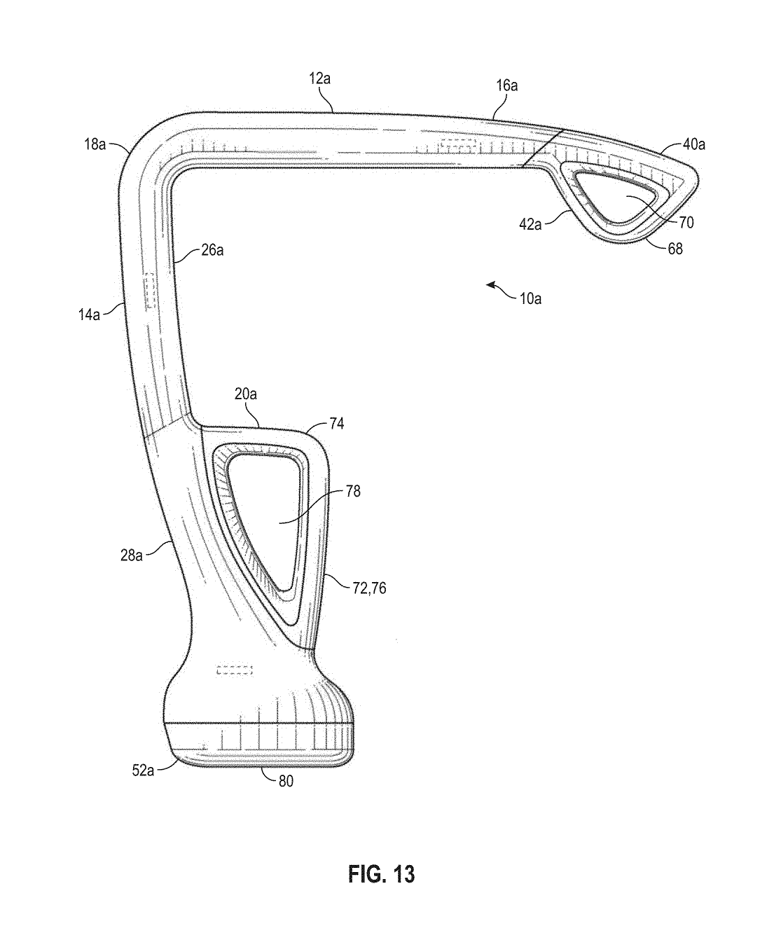

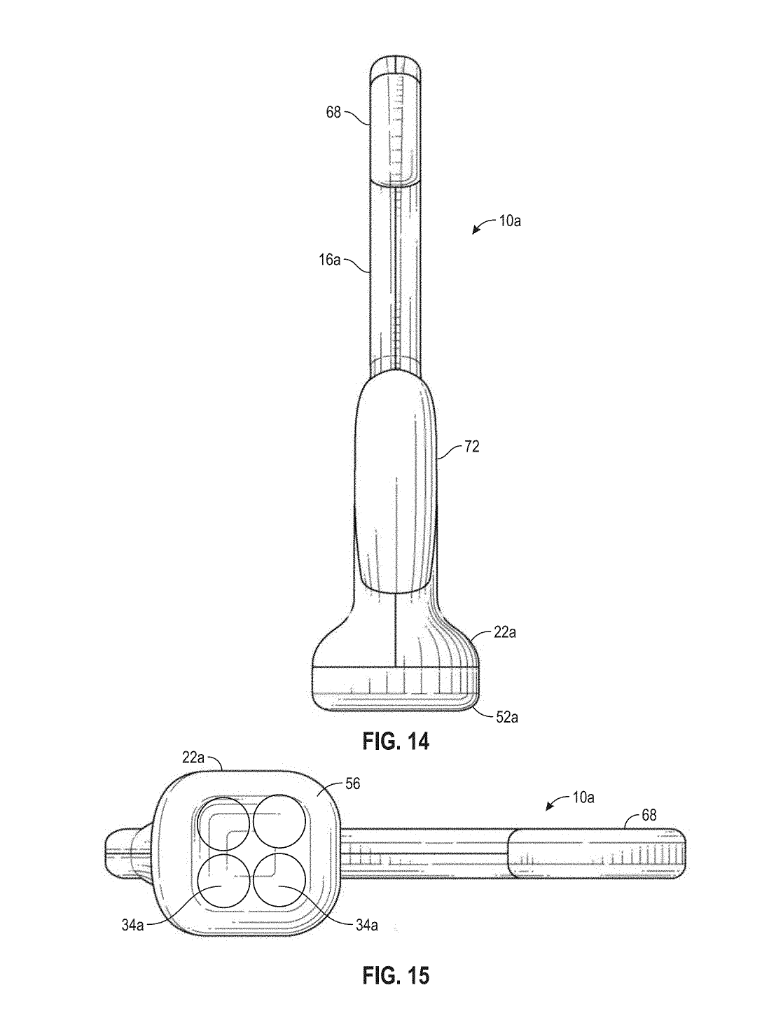

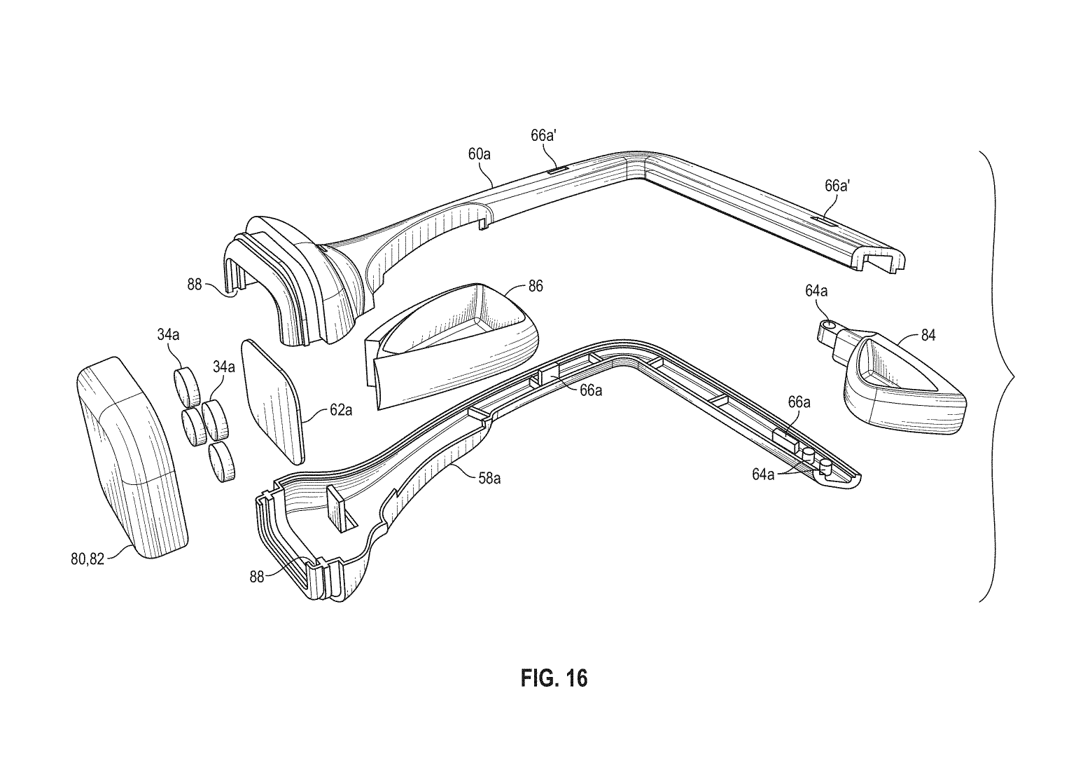

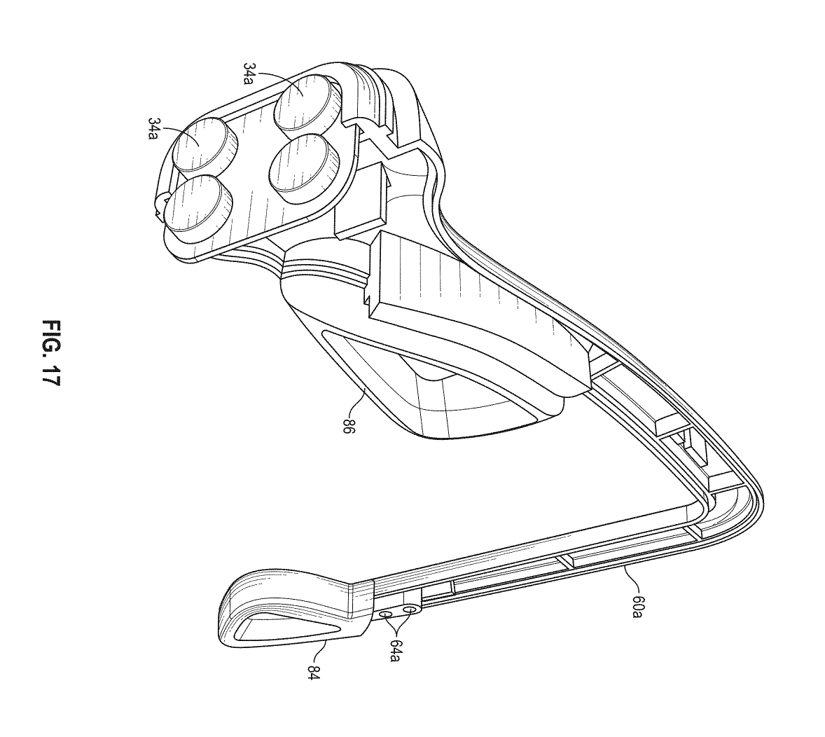

Referring now to FIGS. 10-15, shown therein is another exemplary embodiment of an appliance door holder 10a constructed in accordance with the inventive concepts disclosed and claimed herein. The appliance door holder 10a has a generally F-shaped body 12a with a spine 14a, a first arm 16a extending from a first end 18a of the spine 14a, a second arm 20a extending from the spine 14a in the same direction as the first arm 16a, and a foot 22a at a second end 24a of the spine 14a. A proximal portion 26a of the spine 14a extends between the first arm 16a and second arm 20a, and a distal portion 28a of the spine 14a extends between the second arm 20a and the foot 22a. As with the previously described appliance door holder 10 shown in FIG. 7, the first and second arms 16a and 20a, respectively, are spaced to receive a door rim 30 of an appliance 32. The first arm 16a has a length sufficient to extend across the door rim 30 of the appliance 32. The foot 22a includes at least one magnet 34a (FIG. 15) for magnetically attaching to a body 36 or an opening sidewall 38 of the appliance 32.

In one embodiment, the first arm 16a and the second arm 20a extend in a direction perpendicular to the proximal portion 26a of the spine 14a.

In one embodiment, a distal end 40a of the first arm 16a includes a catch 68 extending generally inwardly toward the foot. The catch 68 can be triangular extending inwardly and back toward the first arm 16a to form a loop. The triangular catch 68 can include a lip 42a and an opening or eye 70. In use, the lip 42a can be placed to catch the door rim 30 to secure the appliance door 44 between the first arm 16a and the second arm 20a. The eye 70 allows a user to easily grasp the appliance door holder 10a with a single finger, or it can be purely ornamental.

In one embodiment, a leg 72 extends from a distal end 74 of the second arm 20a to the foot 22a, thereby forming a triangular handle 76 with an opening 78.

The at least one magnet 34a can be positioned at a distal end 52a of the foot 22a. In one embodiment, placement of multiple magnets 34a, for example four magnets as shown in FIG. 15, on or adjacent a surface 80 of the distal end 52a of the foot 22a, provides a large magnetic surface for attaching to the opening sidewall 38 of the appliance 32.

The at least one magnet 34a can be on an exterior of the surface 80 of the foot 22a, within the foot but partially exposed on the exterior of surface 80 of the foot 22a, or completely enclosed within the foot 22a. Marring or scratching of the appliance surface can be lessened or minimized by enclosing the at least one magnet 34a within the foot 22a.

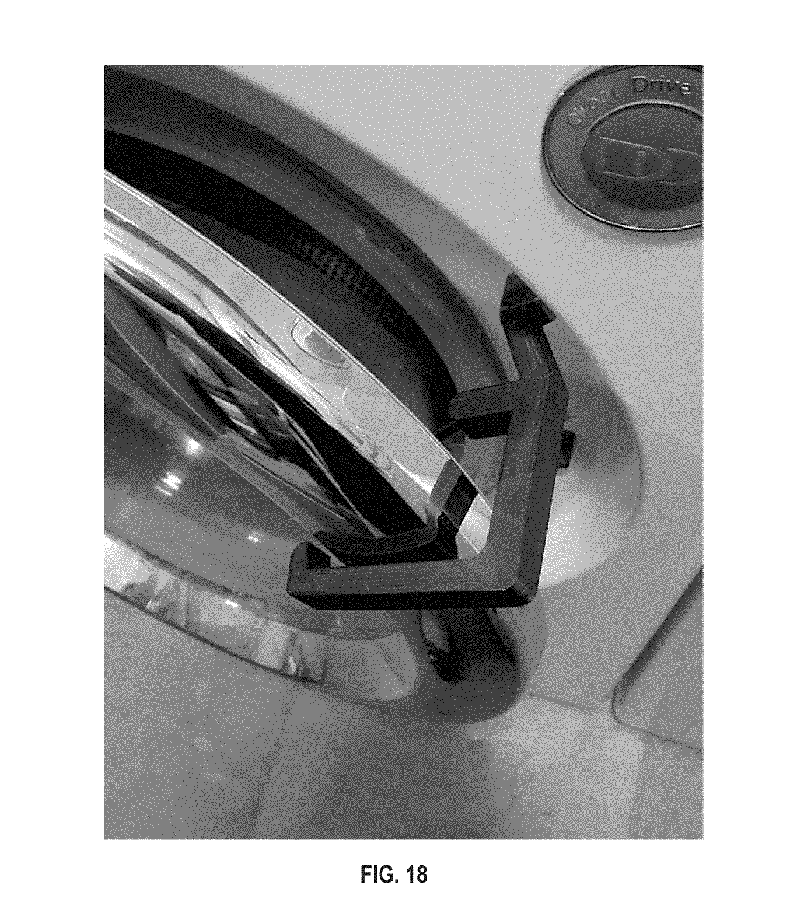

Referring now to FIGS. 17 and 18, in one exemplary embodiment, the appliance door holder 10a is constructed of two main pieces, a base 58a and a lid 60a, as well as a cap 82, a triangular loop piece 84, and a triangular handle piece 86. Magnets 34a are positioned within the cap 82 using a magnet containment wall 62a which is held in place within foot grooves 88 in the base 58a and the lid 60a. To assist in alignment of the base 58a and triangular loop piece 84, positioning pins 64a are arranged such that positioning pins 64a in the base 58 are received by orifices in positioning pins 64a in the lid 60 and the triangular loop piece 84. The base 58 is attached to the lid 60 using clip components 66 and 66′ to achieve a snap fit.

The one or more magnets 34a can be made of ceramic ferrite, rare earths, and other materials known to those skilled in the art. For example, suitable permanent magnetic materials include strontium ferrite, samarium cobalt, neodymium iron boride, alnico (aluminum, nickel, cobalt). The magnet shape can be a rectangular bar, round bar, disc(s), and the like.

The appliance door holder 10a can be made of plastic, wood, natural and synthetic rubber, composites, combinations thereof, or other material(s) compatible with the appliance 32. In one embodiment, the appliance door holder 10a is formed of a thermoplastic. Nonlimiting examples of suitable thermoplastics include acrylic, polyethylene, polypropylene, polystyrene, and polyvinyl chloride.

In one embodiment, the appliance door holder 10a can be made from a thermosetting polymer. Nonlimiting examples of thermosetting polymers include acrylic resins, epoxy, polyurethane, and the like.

In one embodiment, the appliance door holder 10a is formed of a flexible material. This allows the appliance door holder 10a to deform and recover without breaking when, for example, a person pushes against the appliance door while the appliance door holder 10a is in place. Polymeric materials used for the flexible plastic appliance door holder 10a, include but are not limited to, polyolefins, polyesters, polyam ides (NYLON™), and poly(tetrafluoroethylene) (TEFLON®).

In one embodiment, the base 58a and lid 60a of the appliance door holder 10a are formed of a material that is different from the material used to form the triangular loop piece 84 and the triangular handle piece 86. Since portions of the triangular loop piece 84 and the triangular handle piece 86 will contact the appliance door 40, in one embodiment the triangular loop piece 84 and the triangular handle piece 86 are made of a softer and more flexible material than the base 58a and lid 60a of the appliance door holder 10a.

The appliance door holder 10a can be manufactured using processes such as injection molding, press molding, generative fabrication process, and the like.

In one embodiment, the appliance door holder 10a is manufactured using a generative fabrication process. Examples of suitable generative fabrication processes include, but are not limited to, stereolithography, fused layer modeling, layer laminate manufacturing, 3-D printing, and laser sintering. In one embodiment, the generative fabrication process utilized is 3-D printing.

### PROTOTYPE EXAMPLE 1

An exemplary appliance door holder 10 was manufactured as a prototype using CAD programming and 3-D printing with thermoplastic polylactic acid (PLA). A photograph of the prototype appliance door holder 10 is shown in FIG. 18 holding a front loaded washing machine door in a slightly open position.

### PROTOTYPE EXAMPLE 2

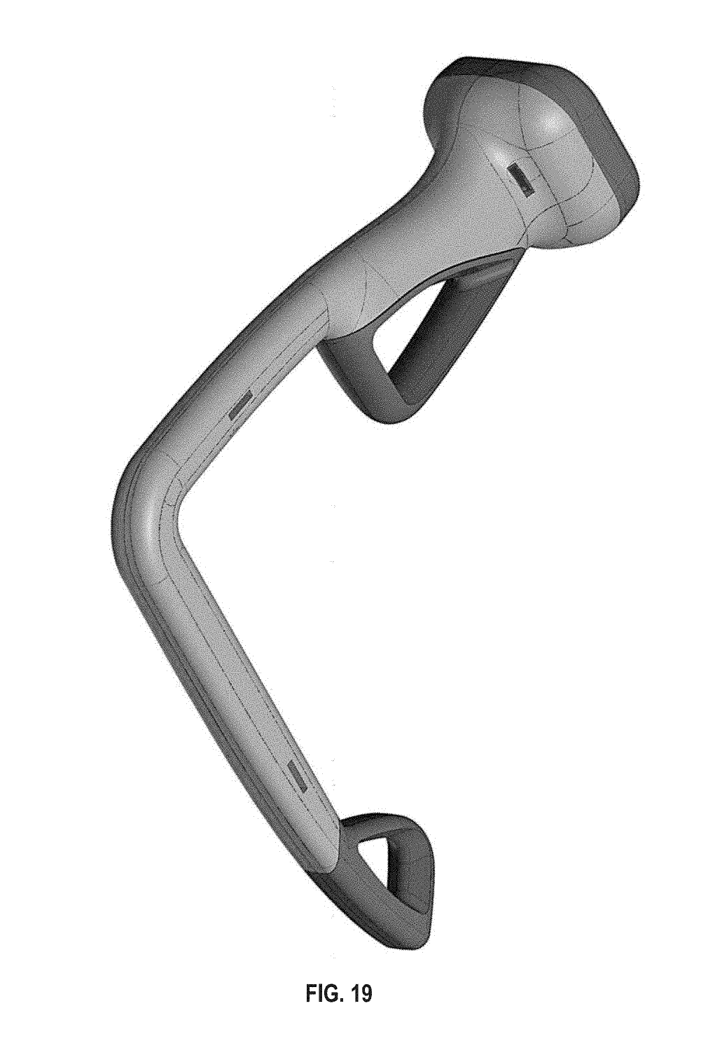

Another exemplary appliance door holder 10a was manufactured as a prototype using CAD programming and 3-D printing with thermoplastic polylactic acid (PLA). A digital image of the second prototype appliance door holder 10a is shown in FIG. 19.

Thus, in accordance with the presently disclosed inventive concept(s), there has been provided appliance door holder, as well as methods of producing and using the same, that fully satisfy the advantages set forth herein above. Although the presently disclosed inventive concept(s) has been described in conjunction with the specific language set forth herein above, it is evident that many alternatives, modifications, and variations will be apparent to those skilled in the art. Additionally, while the prototype appliance door holder was used for a front load washing machine, it is evident that the appliance can be a refrigerator or numerous other appliances having an access door. Accordingly, it is intended to embrace all such alternatives, modifications, and variations that fall within the spirit and broad scope of the presently disclosed inventive concept(s). Changes may be made in the construction and the operation of the various components, elements, and assemblies described herein, as well as in the steps or the sequence of steps of the methods described herein, without departing from the spirit and scope of the presently disclosed inventive concept(s).

What is claimed is:

1. An appliance door holder, comprising:
an F-shaped body having a spine, a first arm extending from a first end of the spine, a second arm extending from the spine in the same direction as the first arm, and a foot at a second end of the spine, wherein a proximal portion of the spine extends between the first arm and second arm, and a distal portion of the spine extends between the second arm and the foot;
wherein the foot comprises at least one magnet; and
wherein the first and second arms are spaced to receive a door rim of an appliance.

2. The appliance door holder of claim 1, wherein the first arm and the second arm extend perpendicular to the proximal portion of the spine.

3. The appliance door holder of claim 1, wherein a distal end of the first arm comprises a lip extending inwardly.

4. The appliance door holder of claim 1, wherein the distal portion of the spine angles inwardly from the proximal portion of the spine.

5. The appliance door holder of claim 1, wherein the distal portion of the spine has a length sufficient to maintain an appliance door partially open when a rim of the appliance door is disposed between the first and second arms of the appliance door holder, and the foot of the appliance door holder is magnetically attached to a body or an opening sidewall of the appliance.

6. An appliance door holder, comprising:
a generally F-shaped body having a spine, a first arm extending from a first end of the spine, a second arm extending from the spine in the same direction as the first arm, a proximal portion of the spine extending between the first arm and second arm, and a foot at a second end of the spine;
wherein the foot comprises at least one magnet; and
wherein the first and second arms are spaced apart to receive a door rim of an appliance.

7. The appliance door holder of claim 6, wherein the first arm and the second arm extend perpendicular to the proximal portion of the spine.

8. The appliance door holder of claim 6, wherein a distal end of the first arm comprises a catch extending inwardly toward the foot.

9. The appliance door holder of claim 6, wherein a distal end of the first arm comprises a triangular catch extending inwardly to form a triangular loop.

10. The appliance door holder of claim 6, further comprising a leg extending from a distal end of the second arm to the foot.

11. The appliance door holder of claim 10, wherein the second arm, the leg, and a distal portion of the spine extending between the second arm and the foot, form a triangular handle piece.

12. The appliance door holder of claim 6, wherein a distal portion of the spine extending between the second arm and the foot has a length sufficient to maintain an appliance door partially open when the door rim of the appliance is disposed between the first and second arms of the appliance door holder, and the foot of the appliance door holder is magnetically attached to a body or an opening sidewall of the appliance.

13. A method of using the appliance door holder of claim 1, the method comprising the steps of:
positioning the first and second arms about the door rim of an appliance door; and
positioning and magnetically attaching the foot to a body or opening sidewall of the appliance such that the appliance door is held in a partially open position.

14. A method of using the appliance door holder of claim 6, the method comprising the steps of:
positioning the first and second arms about the door rim of the appliance; and
positioning and magnetically attaching the foot to a body or opening sidewall of the appliance such that the appliance door is held in a partially open position.
